(19) United States
(12) Patent Application Publication
(10) Pub. No.: US 2018/0005201 A1
(43) Pub. Date: Jan. 4, 2018

(54) SYSTEMS, MEDIA, AND METHODS FOR MAKING CHARITABLE DONATIONS BASED ON USER CONFIGURED EVENTS

(71) Applicant: ITCH APP, INC., Los Angeles, CA (US)

(72) Inventor: Brett Sean JACOBSON, Los Angeles, CA (US)

(21) Appl. No.: 15/547,468

(22) PCT Filed: Jan. 29, 2016
(86) PCT No.: PCT/US2016/015608

§ 371 Date: Jul. 28, 2017

Related U.S. Application Data
(60) Provisional application No. 62/109,502, filed on Jan. 29, 2015.

(51) Int. Cl. G06Q 20/08; G06Q 50/00

(52) U.S. Cl. CPC G06Q 20/08; G06Q 50/01

(57) ABSTRACT

Applications for automatically transacting charitable donations triggered by location-based events and activities. The applications aggregate triggered donations and conduct a financial transaction when the aggregate amount meets or exceeds a pre-determined threshold. The applications also generate an audible notification to the user and others nearby when each donation is triggered.

### CROSS-REFERENCE TO RELATED APPLICATIONS

This application claims the benefit of U.S. Patent Application No. 62/109,502, filed Jan. 29, 2015, the entire disclosure of which is hereby incorporated herein by reference.

### BACKGROUND OF THE INVENTION

According to the Urban Institute, National Center for Charitable Statistics, in 2013 there were over 1.5 million charitable organizations in the United States. The Center on Philanthropy at Indiana University reports that 95.4% of American households give to charity and that the average annual household contribution is $2,974. In 2013, Americans gave a total of approximately $335.17 billion, which reflects a 4.4% increase from 2011.

### SUMMARY OF THE INVENTION

While many people are generous and make substantial charitable contributions, significant barriers exist, artificially suppressing further charity. Current charitable donation methodologies fail to adequately integrate charitable giving into the flow of the daily lives of donors. For example, having to take time away from work and family to drop off donated items, write a check to a worthy cause, or even visit a web site to make an online contribution, may prevent a contemplated act of charity. What is needed is technology that lowers barriers to charitable giving, integrates giving into the daily lives of donors, and links giving to other positive aspects of a donor's life.

Moreover, when individuals make a meaningful, yet modest charitable contribution, they are often not adequately recognized. Existing charitable donation methodologies may communicate a “thank you,” but fail to utilize the social fabric of a donor's life to encourage and acknowledge donations.

Additionally, while some donors can afford to make large donations, the vast majority of Americans would benefit from increased ability to make many, but more frequent microdonations. An existing problem with microdonations is that the many small transactions clutter financial statements and are difficult to track and report.

Advantages of the platforms, systems, media, and methods described herein include, but are not limited to: features allowing a donor to affirmatively link charitable donations to the events and actions they take in their daily lives; features allowing a donor to automatically make donations when these events and actions occur; features generating donation notifications that draw upon the positive reinforcement and recognition available through social connections; and features aggregating many small transactions into a single transaction to detangle tracking and reporting of tax-deductible contributions.

In one aspect, disclosed herein are computer-implemented systems comprising: a digital processing device comprising an operating system configured to perform executable instructions and a memory; a computer program including instructions executable by the digital processing device to create an event-driven, automated donation application comprising: a software module configured to identify one or more charities for a user, the charities identified at least in part by the user's online behavior; a software module configured to provide an interface allowing the user to set parameters for a donation, the parameters comprising a charity, an amount, and at least one trigger event, the charity selected from the one or more identified charities or separately identified by the user, each trigger event associated with at least one location; a software module configured to provide an interface allowing the user to set a donation limit for a charity or for a time period; a software module configured to determine the location of the user, compare the user's location to locations associated with trigger events, and trigger a donation when the user's location matches that of a trigger event; a software module configured to utilize the digital processing device to generate an audible notification to the user and others nearby when a donation is triggered; and a software module configured to aggregate all triggered donations and conduct a financial transaction, from the user to one or more charities, when the aggregate amount meets or exceeds a pre-determined threshold. In some embodiments, the online behavior comprises likes in social media. In some embodiments, the online behavior comprises interests configured in a social media profile. In some embodiments, the application further comprises a software module configured to provide a dashboard interface allowing the user to view total amounts being donated to each charity across all users. In further embodiments, the dashboard interface allows the user to view trending charities. In some embodiments, the application further comprises a software module configured to make a post to a social media platform when a donation is triggered. In some embodiments, the application further comprises a software module configured to set parameters for a special donation event, the parameters comprising a charity, an amount, and at least one trigger event, each trigger event associated with at least one location, wherein participation in the special donation event is available to connections of the user and connections of any participating user. In some embodiments, the application further comprises a software module configured to generate a charitable donation report adapted for tax return preparation. In some embodiments, the application further comprises a software module configured to provide an interface allowing the user to immediately donate a specified amount to a specified charity.

In another aspect, disclosed herein are non-transitory computer-readable storage media encoded with a computer program including instructions executable by a processor to create an event-driven, automated donation application comprising: a software module configured to identify one or more charities for a user, the charities identified at least in part by the user's online behavior; a software module configured to provide an interface allowing the user to set parameters for a donation, the parameters comprising a charity, an amount, and at least one trigger event, the charity selected from the one or more identified charities or separately identified by the user, each trigger event associated with at least one location; a software module configured to provide an interface allowing the user to set a donation limit for a charity or for a time period; a software module configured to determine the location of the user, compare the user's location to locations associated with trigger events, and trigger a donation when the user's location matches that of a trigger event; a software module configured to utilize the digital processing device to generate an audible notification to the user and others nearby when a donation is triggered; and a software module configured to aggregate all triggered donations and conduct a financial transaction, from the user to one or more charities, when the aggregate amount meets or exceeds a pre-determined threshold. In some embodiments, the online behavior comprises likes in social media. In some embodiments, the online behavior comprises interests configured in a social media profile. In some embodiments, the application further comprises a software module configured to provide a dashboard interface allowing the user to view total amounts being donated to each charity across all users. In further embodiments, the dashboard interface allows the user to view trending charities. In some embodiments, the application further comprises a software module configured to make a post to a social media platform when a donation is triggered. In some embodiments, the application further comprises a software module configured to set parameters for a special donation event, the parameters comprising a charity, an amount, and at least one trigger event, each trigger event associated with at least one location, wherein participation in the special donation event is available to connections of the user and connections of any participating user. In some embodiments, the application further comprises a software module configured to generate a charitable donation report adapted for tax return preparation. In some embodiments, the application further comprises a software module configured to provide an interface allowing the user to immediately donate a specified amount to a specified charity.

### DETAILED DESCRIPTION OF THE INVENTION

Described herein, in certain embodiments, are computer-implemented systems comprising: a digital processing device comprising an operating system configured to perform executable instructions and a memory; a computer program including instructions executable by the digital processing device to create an event-driven, automated donation application comprising: a software module configured to identify one or more charities for a user, the charities identified at least in part by the user's online behavior; a software module configured to provide an interface allowing the user to set parameters for a donation, the parameters comprising a charity, an amount, and at least one trigger event, the charity selected from the one or more identified charities or separately identified by the user, each trigger event associated with at least one location; a software module configured to provide an interface allowing the user to set a donation limit for a charity or for a time period; a software module configured to determine the location of the user, compare the user's location to locations associated with trigger events, and trigger a donation when the user's location matches that of a trigger event; a software module configured to utilize the digital processing device to generate an audible notification to the user and others nearby when a donation is triggered; and a software module configured to aggregate all triggered donations and conduct a financial transaction, from the user to one or more charities, when the aggregate amount meets or exceeds a pre-determined threshold.

Also described herein, in certain embodiments, are non-transitory computer-readable storage media encoded with a computer program including instructions executable by a processor to create an event-driven, automated donation application comprising: a software module configured to identify one or more charities for a user, the charities identified at least in part by the user's online behavior; a software module configured to provide an interface allowing the user to set parameters for a donation, the parameters comprising a charity, an amount, and at least one trigger event, the charity selected from the one or more identified charities or separately identified by the user, each trigger event associated with at least one location; a software module configured to provide an interface allowing the user to set a donation limit for a charity or for a time period; a software module configured to determine the location of the user, compare the user's location to locations associated with trigger events, and trigger a donation when the user's location matches that of a trigger event; a software module configured to utilize the digital processing device to generate an audible notification to the user and others nearby when a donation is triggered; and a software module configured to aggregate all triggered donations and conduct a financial transaction, from the user to one or more charities, when the aggregate amount meets or exceeds a pre-determined threshold.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Charities

In some embodiments, the platforms, systems, media, and methods described herein include charities. In some embodiments, one or more charities are identified that would be of interest to a user. In other embodiments, a user identifies one or more charities that they find to be of interest. In other embodiments, a user manually configures charities which are shared to his social media connections. In other embodiments, a user views trending charities through a dashboard interface.

In some embodiments, charities include, by way of non-limiting examples, religious charities, animal charities, wildlife conservation organizations, pet and animal welfare organizations, hunting & fishing conservation groups, zoos and aquariums, environmental charities, environmental conservation & protection, parks and nature centers, disaster relief and humanitarian non-governmental organizations (NGOs), peace and human rights NGOs, conservation NGOs, child sponsorship organizations, homeless services, disease & disorder charities, medical services & treatment, medical research charities, patient and family support charities, private elementary, junior high, and high schools, universities and colleges, scholarship and financial aid services, school reform and experimental education, support for students, teachers, and parents, museums & art galleries, performing arts, libraries and historical societies, public broadcasting and media, advocacy and civil rights fundraising organizations, research and public policy institutions, community foundations, community and housing development, and combinations thereof.

### Online Behavior

In some embodiments, the platforms, systems, media, and methods described herein include a software module configured to analyze user online behavior to identify one or more charities for a user. In further embodiments, a user online behavior comprises likes in social media. In other further embodiments, a user online behavior comprises interests configured in a social media profile. In other embodiments, a user online behavior can be shared among social media connections.

### Trigger Events

In some embodiments, the platforms, systems, media, and methods described herein include trigger events. In other embodiments, charities are associated with trigger events wherein donations are made to associated charities when the trigger events are triggered. In other embodiments, trigger events are associated with at least one location. In other embodiments, trigger events are associated with a credit card payment, a debit card payment, a PayPal payment, an ApplePay, a Google Wallet, or other electronic/online payments.

In other embodiments, trigger events include, by way of non-limiting examples, exercising in a gym, shopping at a gas station, shopping in a grocery store, online shopping, going to a church service, attending a public event, using a library, hiking on a trail, and combinations thereof. In other embodiments, trigger events are optionally self-defined by a user to be any events or even non-events he likes to be associated with charities.

### Geolocation

In some embodiments, the platforms, systems, media, and methods described herein include location-based trigger events, or use of the same. In further embodiments, a user optionally configures a donation to be triggered by an event or activity associated with a particular location. The platforms, systems, media, and methods described herein geolocate the user. When the user's location is determined to be within the location associated with the event or activity of the configured trigger event, the application transacts the donation.

Geolocation is the identification of the real-world geographic location of an object, such as a computer, mobile smartphone, or a portable computing device such as a laptop or tablet computer. A location is suitably expressed in a number of ways including, by way of non-limiting examples, geographic coordinates (e.g., latitude and longitude), a place name (e.g., county, city, landmark, intersection, etc.), a physical street address, distance from a given location, presence within a specified radius from a given location, and a graphical depiction on a map. In some cases, geolocation involves geocoding to find associated latitude and longitude from other geographic data. In some cases, geolocation involves reverse geocoding to back code latitude and longitude coordinates to a readable address or place name.

Many methods of geolocation are suitable that utilize several underlying sources of location information. In some embodiments, a software module geolocates, for example, a consumer, a mobile processing device, a retail item, or a physical retail outlet using sources of location information including, by way of non-limiting examples, GPS coordinates provided by a processing device, triangulation between mobile phone towers and public masts (e.g., assistive GPS), Wi-Fi connection location, WHOIS performed on IP address or MAC address (e.g., Wi-Fi base station MAC address), GSM/CDMA cell IDs (e.g., identification, triangulation, and multilateration), and location information self-reported by a user. In some embodiments, location information includes position (e.g., latitude and longitude), elevation, heading, speed, orientation, and combinations thereof.

In some embodiments, a software module geolocates, for example, a user or a mobile processing device by using the HTML 5 geolocation API. In light of the disclosure provided herein, those of skill in the art will recognize that the HTML 5 geolocation API is supported in Internet Explorer 9.0+, Firefox 3.5+, Safari 5.0+, Chrome 5.0+, Opera 10.6+, iOS 3.0+, Android 2.0+, and Windows Phone 7.5+. In some embodiments, a software module geolocates, for example, a consumer, a mobile processing device, or a business using methods aligned with W3C Geolocation API (available at: http://dev.w3.org/geo/api/spec-source.html). The W3C Geolocation API defines an interface to location information associated with a processing device (e.g., smartphone, tablet computer, laptop computer, etc.) hosting the implementation, such as latitude and longitude.

In some embodiments, the platforms, systems, media, and methods disclosed herein perform geolocation by one method, such as those disclosed herein. In other embodiments, the platforms, systems, media, and methods disclosed herein perform geolocation by more than one method.

In some embodiments, the geolocation of, for example, a user or a mobile processing device is accurate to within at least 100, 90, 80, 70, 60, 50, 40, 30, 20, 10, 9, 8, 7, 6, 5, 4, 3, 2, 1 or fewer kilometers, including increments therein. In further embodiments, the geolocation is accurate to within at least 1000, 900, 800, 700, 600, 500, 400, 300, 200, 100, 90, 80, 70, 60, 50, 40, 30, 20, 10, 9, 8, 7, 6, 5, 4, 3, 2, 1 or fewer meters, including increments therein.

### Donation Limits

In some embodiments, the platforms, systems, media, and methods described herein include donation limits. In certain embodiments, a user configures a limit on donations to a particular charity. In certain embodiments, a user configures a limit on donations over a particular time period. In certain embodiments, a user configures a limit on donations triggered by a particular event or activity. In other embodiments, when a certain donation limit for a charity is exceeded, the donation is going to the charity next in line associated with certain trigger events. In other embodiments, when a donation limit for a period is not exceeded, this leftover is optionally carried over to the next donation period. In other embodiments, when a donation limit for a charity is exceeded, a notification is sent to the user.

### Audible Notifications

In some embodiments, the platforms, systems, media, and methods described herein include audible notifications. In further embodiments, a software module utilizes a digital processing device to generate an audible notification to the user and others nearby when a donation is triggered. In a particular embodiment, the audible notification comprises a scratching sound effect.

### Aggregation of Donations

In some embodiments, the platforms, systems, media, and methods described herein include aggregation of donations. In further embodiments, triggered donations are aggregated and transacted only when the aggregate amount meets or exceeds a pre-determined threshold. In further embodiments, a transaction is conducted if a pre-determined period is due even when an aggregation of donations does not exceed a pre-determined threshold. In further embodiments, a user views an aggregation of donations to each charity across all users.

### Dashboard Interface

In some embodiments, the platforms, systems, media, and methods described herein include charitable giving dashboard interface. In further embodiments, a dashboard interface allows a user to view total amounts being donated to each charity across all users. In further embodiments, a dashboard interface allows the user to view trending charities.

### Donation Reports

In some embodiments, the platforms, systems, media, and methods described herein include donation reports. In further embodiments, a user is given donation reports on each charity. In further embodiments, a user is given donation reports on each trigger event. In further embodiments, a user is given donation reports for a certain period of time. In further embodiments, a user utilizes a charitable donation report to adapt for tax return preparation.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD® , Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple° Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFushion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM Lotus Dominco®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry° App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB.NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, charity, event, and location information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

Mark, a 36-year-old engineer working for a high-tech company, is married with two children. He and his family are living a stable life in a metro suburb. In addition to continuing the pursuit of his career development like the previous 8 years since his graduation as a Ph.D., he tries to pay more attention to his health like college days and give back to the society by helping less fortunate people. He has set a goal to get back to an ideal weight and run a 5K with his two kids. Other than contributing to the church he goes to every Sunday and the American Cancer Society, he also wants to set up a unique charity specifically for breast cancer for his late mother. Stuck with work and the care for the kids, however, he often finds himself little time to do either of those especially with the inconvenience to do them.

On Jan. 1, 2015, he makes a New Year's Resolution to exercise more and repay society at the same time. To achieve his resolution, Mark uses his smart phone to access a software module of a charitable donation app that allows him to configure automatically transacting charitable donations triggered by events and activities in his daily life. The software module provides him the option to configure charitable donation events by either selecting charities or by creating his own charities. Mark also has the option of allowing the app to recommend charities based on his online behaviors, such as his likes in social media, interests configured in a social media profiles, web browsing, and previous charitable activity. Mark uses an interface provided by a software module to set parameters for a donation, including, a charity, an amount, and a trigger event associated with a location.

As Mark proceeds through his daily activities, a software module associated with the app is configured to determine Mark's location, compare Mark's location to locations associated with trigger events, and trigger a donation when Mark's location matches that of a trigger event. Hence, Mark sets the Breast Cancer Foundation to be his target charity, and the trigger event to be his exercise in a gym near his home. Thus, each time he exercises in that gym, the software module automatically makes a $0.25 on his behalf.

### Example 2

Referring to the engineer in Example 1, during the year, Mark finds that he wants to expand his triggering events and locations and the related charities. There is an annual 5K/10K Fall Classic Run in October, and to encourage himself to attend that event, Mark sets a bigger donation of $20 for participating that running event. He also wants to contribute $1.00 to his church whenever he attends service on Sundays. In addition, he wants to contribute to Children's Education Program whenever he shops at a gas station and his favorite Whole Foods store. A software module provides Mark the option to configure multiple triggering events and locations and multiple charities, and the option to make different connections among them.

At the same time, Mark has to consider his own financial situation and wants to set a $300 upper limit for each month and $3,000 limit for the whole year. He also tries to distribute his contribution more evenly to different charities so that whenever he has contributed to one charity for $500, the donation triggered by the same triggering event will go to the associated charity next in line. Mark uses a software module to readily set these limits, such as a limit on donations to a particular charity, a limit on donations over a particular time period, and a limit on donations triggered by a particular event or activity.

### Example 3

Referring to the engineer in Example 2, during each triggering event, Mark oftentimes donates a micro-donation of $0.25 or $0.50. It's inconvenient to complete a financial transaction for each micro-donation, so he wants to finalize a transaction to a charity only when the donations to that charity accumulate to over $10. He configures his app to aggregate all triggered donations and conduct a financial transaction, from the user to the charities, when the aggregate amount meets or exceeds this pre-determined threshold. In addition, Mark wants to trace the amount he donates to each charity after a while, hence to make adjustments to charities events or go to some triggering events more often. He uses a dashboard interface provided by a software module to view total amounts being donated to each charity across all users. The software module provides a report feature and can generalize for monthly or yearly donations for Mark. In addition, Mark uses the software module to generate a charitable donation report adapted for tax return preparation.

Sometimes, there is a need for Mark to donate to a charity a certain amount before some particular time. Instead of waiting for those micro-donations through the triggering events, He uses an interface provided by a software module to immediately donate a specified amount to a specified charity just like traditional donation methods.

### Example 4

Referring to the engineer in Example 3, Mark would like to have others join his charitable donations based on configured events. A software module is configured to utilize the digital processing device to generate an audible notification to Mark and others nearby when a donation is triggered. Mark also encourages family, friends and other connections through social recognition using a software module which makes a post to a social media platform when a donation is triggered. On the other hand, Mark discovers new activities when a dashboard interface provided by the software module allows him to view trending charities. The dashboard interface is also used by Mark to view total amounts being donated to each charity across all users.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising:
a. a digital processing device comprising an operating system configured to perform executable instructions and a memory;
b. a computer program including instructions executable by the digital processing device to create an event-driven, automated donation application comprising:
i. a software module configured to identify one or more charities for a user, the charities identified at least in part by the user's online behavior;
ii. a software module configured to provide an interface allowing the user to set parameters for a donation, the parameters comprising a charity, an amount, and at least one trigger event, the charity selected from the one or more identified charities or separately identified by the user, each trigger event associated with at least one location;
iii. a software module configured to provide an interface allowing the user to set a donation limit for a charity or for a time period;
iv. a software module configured to determine the location of the user, compare the user's location to locations associated with trigger events, and trigger a donation when the user's location matches that of a trigger event;
v. a software module configured to utilize the digital processing device to generate an audible notification to the user and others nearby when a donation is triggered; and
vi. a software module configured to aggregate all triggered donations and conduct a financial transaction, from the user to one or more charities, when the aggregate amount meets or exceeds a pre-determined threshold.

2. The system of claim 1, wherein the online behavior comprises likes in social media.

3. The system of claim 1, wherein the online behavior comprises interests configured in a social media profile.

4. The system of claim 1, wherein the application further comprises a software module configured to provide a dashboard interface allowing the user to view total amounts being donated to each charity across all users.

5. The system of claim 4, wherein the dashboard interface allows the user to view trending charities.

6. The system of claim 1, wherein the application further comprises a software module configured to make a post to a social media platform when a donation is triggered.

7. The system of claim 1, wherein the application further comprises a software module configured to set parameters for a special donation event, the parameters comprising a charity, an amount, and at least one trigger event, each trigger event associated with at least one location, wherein participation in the special donation event is available to connections of the user and connections of any participating user.

8. The system of claim 1, wherein the application further comprises a software module configured to generate a charitable donation report adapted for tax return preparation.

9. The system of claim 1, wherein the application further comprises a software module configured to provide an interface allowing the user to immediately donate a specified amount to a specified charity.

10. The system of claim 1, wherein the trigger events are associated with a credit card payment, a debit card payment, a PayPal payment, an ApplePay payment, a Google Wallet payment, or other electronic/online payments.

11. The system of claim 1, wherein the application further comprises a software module configured to make donation to a second charity associated with a trigger event when a donation limit for a first charity is exceeded.

12. The system of claim 1, wherein the application further comprises a software module configured to carry over a portion of a donation to a next donation period when a donation limit for the current period is exceeded.

13. Non-transitory computer-readable storage media encoded with a computer program including instructions executable by a processor to create an event-driven, automated donation application comprising:
a. a software module configured to identify one or more charities for a user, the charities identified at least in part by the user's online behavior;
b. a software module configured to provide an interface allowing the user to set parameters for a donation, the parameters comprising a charity, an amount, and at least one trigger event, the charity selected from the one or more identified charities or separately identified by the user, each trigger event associated with at least one location;
c. a software module configured to provide an interface allowing the user to set a donation limit for a charity or for a time period;
d. a software module configured to determine the location of the user, compare the user's location to locations associated with trigger events, and trigger a donation when the user's location matches that of a trigger event;
e. a software module configured to utilize the digital processing device to generate an audible notification to the user and others nearby when a donation is triggered; and
f. a software module configured to aggregate all triggered donations and conduct a financial transaction, from the user to one or more charities, when the aggregate amount meets or exceeds a pre-determined threshold.

14. The media of claim 13, wherein the online behavior comprises likes in social media.

15. The media of claim 13, wherein the online behavior comprises interests configured in a social media profile.

16. The media of claim 13, wherein the application further comprises a software module configured to provide a dashboard interface allowing the user to view total amounts being donated to each charity across all users.

17. The media of claim 16, wherein the dashboard interface allows the user to view trending charities.

18. The media of claim 13, wherein the application further comprises a software module configured to make a post to a social media platform when a donation is triggered.

19. The media of claim 13, wherein the application further comprises a software module configured to set parameters for a special donation event, the parameters comprising a charity, an amount, and at least one trigger event, each trigger event associated with at least one location, wherein participation in the special donation event is available to connections of the user and connections of any participating user.

20. The media of claim 13, wherein the application further comprises a software module configured to generate a charitable donation report adapted for tax return preparation.

21. The media of claim 13, wherein the application further comprises a software module configured to provide an interface allowing the user to immediately donate a specified amount to a specified charity.

22. The media of claim 13, wherein the trigger events are associated with a credit card payment, a debit card payment, a PayPal payment, an ApplePay payment, a Google Wallet payment, or other electronic/online payments.

23. The media of claim 13, wherein the application further comprises a software module configured to make donation to a second charity associated with a trigger event when a donation limit for a first charity is exceeded.

24. The media of claim 13, wherein the application further comprises a software module configured to carry over a portion of a donation to a next donation period when a donation limit for the current period is exceeded.
